(19) United States
(12) Patent Application Publication
(10) Pub. No.: US 2005/0060308 A1
(43) Pub. Date: Mar. 17, 2005

(54) System, method, and recording medium for coarse-to-fine descriptor propagation, mapping and/or classification

(75) Inventors: Milind R. Naphade, Fishkill, NY (US); Apostol I. Natsev, White Plains, NY (US); John R. Smith, New Hyde Park, NY (US)

Correspondence Address: MCGINN & GIBB, PLLC, 8321 OLD COURTHOUSE ROAD, SUITE 200, VIENNA, VA, 22182-3817, US

(73) Assignee: International Business Machines Corporation, Armonk, NY (US)

(21) Appl. No.: 10/647,540

(22) Filed: Aug. 26, 2003

(51) Int. Cl. G06F 17/30

(52) U.S. Cl. 707/5

(57) ABSTRACT

A method, system and recording medium in which descriptors at a first granularity level are propagated, mapped, and/or classified to generate an output content having descriptors at a second granularity level that is finer than the first granularity level.

### BACKGROUND OF THE INVENTION

1. Field of the Invention

The present invention generally relates to a method and system that annotates data. More particularly, the present invention relates to a system and method that may have been provided at a coarse content granularity and automatically propagates or maps those annotations to a finer content granularity.

2. Description of the Related Art

Enabling semantic detection and indexing may be an important task in multimedia content management. Learning and classification techniques are increasingly relevant to state of the art content management systems. From relevance feedback to statistical semantic modeling, there is a shift in the amount of manual supervision needed, from light-weight classifiers to heavyweight classifiers. It is therefore natural that machine learning and classification techniques are making an increasing impression on the state of the art in media indexing and retrieval.

### SUMMARY OF THE INVENTION

Techniques such as relevance feedback may be thought of as non-persistent lightweight binary classifiers using incremental learning to improve retrieval performance. Other techniques may require considerable supervision during the process of building a detector and may not need a learning component during a detection phase. If good detection is expected without having to spend precious annotation time, techniques should be developed to address the challenge of minimizing annotation effort without sacrificing the quality of annotation.

It is here that learning techniques for disambiguation can play an important role. One way to speed up annotation is to deploy active learning during annotation (see, for example, M. Naphade, C.-Y. Lin, J. R. Smith, B. Tseng, S. Basu, “Learning to Annotate Video Databases”, Proc. IS&T/SPIE Symp. on Electronic Imaging: Science and Technology—Storage & Retrieval for Image and Video Databases X, San Jose, Calif., January, 2002). The use of active learning during annotation implies a pro-active role of the system in selecting samples that when annotated would result in maximum disambiguation. Such techniques have been shown to cut down on the number of samples that need to be annotated by an order of magnitude.

An orthogonal approach for concepts that have regional support is to accept annotations at coarser granularity. While building a model for the regional concept “Sky”, the user is, thus, not required to select the region in the image which corresponds to this regional label. It is up to the system then, to learn from several possible positive and negatively annotated examples, how to represent the concept “Sky” using regional features.

This learning paradigm which disambiguates across granularity is called multiple instance learning (A. L. Ratan, O. Maron, W. E. L. Grimson, and T. LozanoPrez. A framework for learning query concepts in image classification. In CVPR, pp. 423-429, 1999) and was originally applied to problems in drug discovery.

No technique exists at present that can allow the user to annotate content at any granularity that is coarser than the granularity at which the annotation actually exists, where the technique then propagates or maps the annotation to the appropriate content granularity.

Therefore, as recognized by the present inventors, there is an acute need for a system and method of developing coarse to fine descriptor mapping, and propagation, particularly in the domain of multimedia.

Semantic Content Indexing and Retrieval and Processing requires semantically annotated content. Thus, it is necessary to develop content annotation tools that allow users to associate the annotations with content with minimal interaction. However, the abundance of content and diversity of annotations makes this a difficult and overly expensive task. In particular, the task of associating the annotation with the appropriate content granularity is extremely expensive.

In view of the foregoing and other exemplary problems, drawbacks, and disadvantages of the conventional methods and structures, an exemplary feature of the present invention is to provide a method, system and recording medium in which descriptors at a first granularity level are propagated, mapped, or classified to generate an output content having descriptors at a second granularity level that is finer than the first granularity level.

In a first exemplary aspect of the present invention, a descriptor propagation system that includes a descriptor acceptance device that accepts a first descriptor associated with a first content granularity, and a descriptor generator device that generates a second descriptor associated with a second content granularity based on the first descriptor, where the second content granularity is finer than the first content granularity.

In a second exemplary aspect of the present invention, a descriptor mapping system includes a descriptor acceptance device that accepts a first descriptor at a first content granularity, an information repository that stores a mapping function, and a descriptor generator device that generates a second descriptor at a second content granularity which is finer than the first content granularity based upon the first descriptor and the mapping function.

In a third exemplary aspect of the present invention, a descriptor classification system includes a descriptor acceptance device that accepts a first content that includes a first descriptor at a first content granularity, and a descriptor generator device that generates an output content that includes the first descriptor at a second content granularity based upon a second content at the first content granularity, where the second content granularity is finer than the first content granularity.

In a fourth exemplary aspect of the present invention, a method for propagating descriptors includes accepting a first descriptor at a first content granularity, analyzing the first content to determine a propagation function that correlates the first descriptor to a second content granularity that is finer than the first content granularity, and outputting the first descriptor at the second content granularity.

In a fifth exemplary aspect of the present invention, a method for mapping descriptors includes accepting a first descriptor at a first content granularity, mapping the first descriptor to a second content granularity that is finer than the first content granularity based upon a mapping function stored in an information repository, and outputting the first descriptor at the second content granularity.

In a sixth exemplary aspect of the present invention, a method for classifying descriptors includes accepting a first content that includes a first descriptor at a first content granularity, generating a classification function based upon the first descriptor, accepting a second content that does not include a descriptor, and providing the first descriptor to the second content at a second content granularity that is finer than the first content granularity based upon the classification function.

In a seventh exemplary aspect of the present invention, a signal-bearing medium tangibly embodying a program of machine-readable instructions executable by a digital processing apparatus to perform a method of propagating descriptors, includes instructions for accepting a first descriptor at a first content granularity, instructions for analyzing the first content to determine a propagation function that correlates the first descriptor to a second content granularity that is finer than the first content granularity, and instructions for outputting the first descriptor at the second content granularity.

In an eighth exemplary aspect of the present invention, a signal-bearing medium tangibly embodying a program of machine-readable instructions executable by a digital processing apparatus to perform a method of mapping descriptors, includes instructions for accepting a first descriptor at a first content granularity, instructions for mapping the first descriptor to a second content granularity that is finer than the first content granularity based upon a mapping function stored in an information repository, and instructions for outputting the first descriptor at the second content granularity.

In a ninth exemplary aspect of the present invention, a signal-bearing medium tangibly embodying a program of machine-readable instructions executable by a digital processing apparatus to perform a method of classifying descriptors, includes instructions for accepting a first content that includes a first descriptor at a first content granularity, instructions for generating a classification function based upon the first descriptor, instructions for accepting a second content that does not include a descriptor, and instructions for providing the first descriptor to the second content at a second content granularity that is finer than the first content granularity based upon the classification function.

In a tenth exemplary aspect of the present invention a method of deploying computing infrastructure in which computer-readable code is integrated into a computing system, such that the code and the computing system combine to perform a method for propagating descriptors. The method includes analyzing a first content at a first content granularity to determine a propagation function that correlates a first descriptor provided for the first content to a second content granularity that is finer than the first content granularity, and outputting the first descriptor at the second content granularity.

In an eleventh exemplary aspect of the present invention a method of deploying computing infrastructure in which computer-readable code is integrated into a computing system, such that the code and the computing system combine to perform a method for mapping descriptors. The method including mapping a first descriptor at a first content granularity to a second content granularity that is finer than the first content granularity based upon a mapping function, and outputting the first descriptor at the second content granularity.

In an twelfth exemplary aspect of the present invention a method of deploying computing infrastructure in which computer-readable code is integrated into a computing system, such that the code and the computing system combine to perform a method for classifying descriptors. The method includes generating a classification function based upon a first descriptor for a first content at a first content granularity, accepting a second content that does not include a descriptor, and providing the first descriptor to the second content at a second content granularity that is finer than the first content granularity based upon the classification function.

An exemplary embodiment of the present invention provides a novel system and method for automatic modeling, propagation and/or mapping of descriptors where the descriptors may have been provided at coarse granularity while the propagation and modeling happens at finer granularity. For example, in multimedia annotation an exemplary embodiment of the present invention permits the user to annotate an image to have “face” in it without having to associate the face-region with the label.

An exemplary embodiment of the present invention provides a method and system that automatically maps, propagates or classifies the face region pixels with the face label (e.g., annotation).

An exemplary embodiment of the present invention provides a system and method that accepts descriptors or annotations at a granularity level and maps, classifies, or propagates those annotations to finer content granularity levels.

An exemplary embodiment of the invention investigates automatic learning based approaches to achieve this goal. As the user starts annotating the content exemplars with descriptors, a learning component of an exemplary embodiment of the present invention propagates the user-provided labels to appropriate content granularity with common characteristics.

An exemplary embodiment of the present invention may also use an information repository to map the user provided descriptors to other relevant descriptors that can be associated with the appropriate content granularity. The repository may be stored and managed explicitly in persistent storage, or it may be implicitly formed and instantiated on-the-fly during the mapping process.

Additionally, an exemplary embodiment of the present invention receives un-annotated content exemplars and generates classified descriptors at the appropriate content granularity based upon the persistent learning and storage of the mapping and propagating functions.

### BRIEF DESCRIPTION OF THE DRAWINGS

The foregoing and other exemplary purposes, aspects and advantages will be better understood from the following detailed description of an exemplary embodiment of the invention with reference to the drawings, in which:

FIG. 1 illustrates an exemplary hardware/information handling system 100 for incorporating the present invention therein;

FIG. 2 illustrates a signal bearing medium 200 (e.g., storage medium) for storing steps of a program of a method according to the present invention;

FIG. 3 shows a video image 300 which includes annotations at a finer granularity level;

FIG. 4 shows the video image 300 which includes the annotations of FIG. 3 at a coarse granularity level;

FIG. 5 shows the video image 300 which includes annotations at a finer granularity level as propagated by an exemplary embodiment of the present invention;

FIG. 6 shows another video image 600 which includes a classified annotation in accordance with another exemplary embodiment of the present invention;

FIG. 7 illustrates various modalities and granularity levels of content;

FIG. 8 shows a diagram that illustrates one modality 800 and corresponding granularity levels 802;

FIG. 9 shows a diagram that illustrates a descriptor 901 having an appropriate granularity level 902;

FIG. 10 shows an exemplary diagram of descriptors which are associated with multiple image granularities;

FIG. 11 is a diagram 1100 of a content exemplar that includes content 1102 and descriptors 1104;

FIG. 12 is a diagram 1200 of an un-annotated exemplar that includes content 1202 without any descriptors;

FIG. 13 is a diagram 1300 of an annotated exemplar that includes content 1302, descriptors 1304 and propagated descriptors 1306;

FIG. 14 is a diagram 1400 of an exemplar that includes content 1402, descriptors 1404 and mapped descriptors 1406;

FIG. 15 is a diagram 1500 of an exemplar that includes content 1502 and classified descriptors 1504;

FIG. 16 shows an annotation propagation system 1600 in accordance with a first exemplary embodiment of the present invention;

FIG. 17 shows a flow chart that illustrates an exemplary control routine for the annotation propagation system 1600 of FIG. 16;

FIG. 18 illustrates that video content may be described at an image level on a map of features;

FIG. 19 illustrates an annotation mapping system 1900 in accordance with another exemplary embodiment of the present invention;

FIG. 20 shows a flow chart that illustrates an exemplary control routine 2000 for the annotation mapping system 1900 of FIG. 19;

FIG. 21 illustrates an annotation classification system 2100 in accordance with yet another exemplary embodiment of the present invention; and

FIG. 22 shows a flow chart that illustrates an exemplary control routine 2200 for the annotation classification system of FIG. 21.

### DETAILED DESCRIPTION OF EXEMPLARY EMBODIMENTS OF THE INVENTION

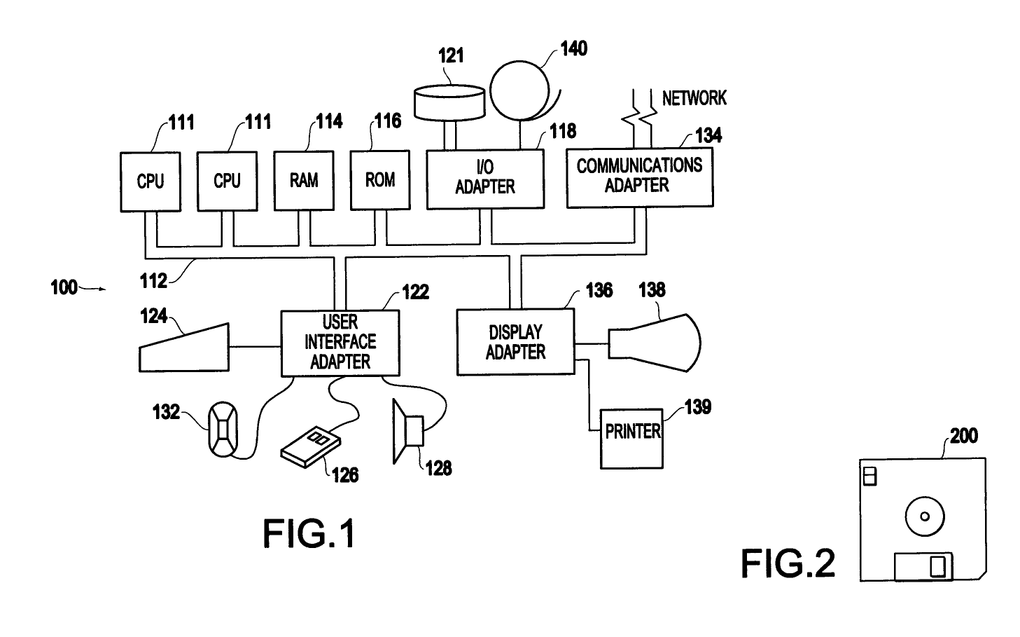

Referring now to the drawings, and more particularly to FIGS. 1-22, there are shown exemplary embodiments of the method and structures according to the present invention.

FIG. 1 illustrates a typical hardware configuration of a content annotation system 100 in accordance with the invention and which preferably has at least one processor or central processing unit (CPU) 111.

The CPUs 111 are interconnected via a system bus 112 to a random access memory (RAM) 114, read-only memory (ROM) 116, input/output (I/0) adapter 118 (for connecting peripheral devices such as disk units 121 and tape drives 140 to the bus 112), user interface adapter 122 (for connecting a keyboard 124, mouse 126, speaker 128, microphone 132, and/or other user interface device to the bus 112), a communication adapter 134 for connecting an information handling system to a data processing network, the Internet, an Intranet, a personal area network (PAN), etc., and a display adapter 136 for connecting the bus 112 to a display device 138 and/or printer 139 (e.g., a digital printer or the like).

In addition to the hardware/software environment described above, a different aspect of the invention includes a computer-implemented method for performing the above method. As an example, this method may be implemented in the particular environment discussed above.

Such a method may be implemented, for example, by operating a computer, as embodied by a digital data processing apparatus, to execute a sequence of machine-readable instructions. These instructions may reside in various types of signal-bearing media.

Thus, this aspect of the present invention is directed to a programmed storage product, comprising signal-bearing media tangibly embodying a program of machine-readable instructions executable by a digital data processor incorporating the CPU 111 and hardware above, to perform the method of the invention.

This signal-bearing media may include, for example, a RAM contained within the CPU 111, as represented by the fast-access storage for example. Alternatively, the instructions may be contained in another signal-bearing media, such as a magnetic data storage diskette 200 (FIG. 2), directly or indirectly accessible by the CPU 111.

Whether contained in the diskette 200, the computer/CPU 111, or elsewhere, the instructions may be stored on a variety of machine-readable data storage media, such as DASD storage (e.g., a conventional “hard drive” or a RAID array), magnetic tape, electronic read-only memory (e.g., ROM, EPROM, or EEPROM), an optical storage device (e.g. CD-ROM, WORM, DVD, digital optical tape, etc.), paper “punch” cards, or other suitable signal-bearing media including transmission media such as digital and analog and communication links and wireless. In an illustrative embodiment of the invention, the machine-readable instructions may comprise software object code.

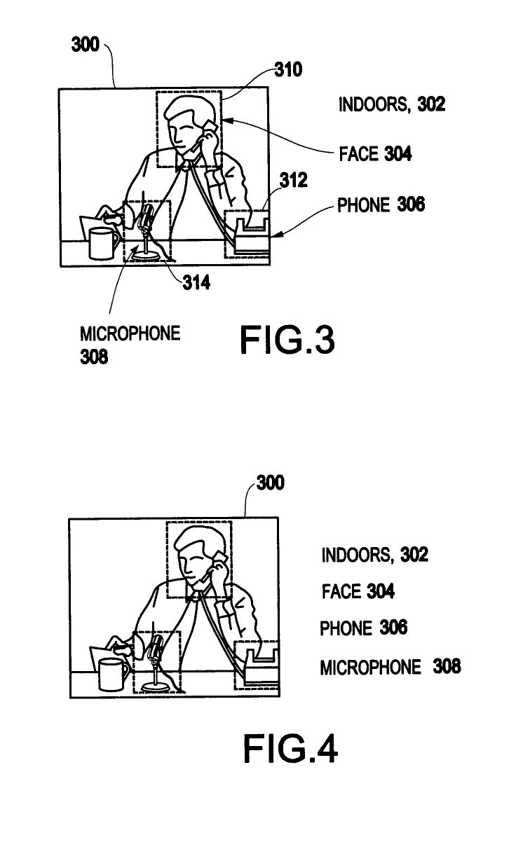

FIG. 3 shows a video image 300 which includes annotations “Indoors” 302, “Face” 304, “Phone” 306, and “Microphone” 308. Each of the annotations corresponds to a particular granularity level. In this example, the annotation “Indoors” 302 corresponds to the relatively coarse granularity level of the entire video image 300, while each of the remaining annotations: “Face” 304, “Phone” 306, and “Microphone” 308 correspond to regions 310, 312 and 314, respectively of the video image 300. The regions represent a relatively finer granularity level.

Generally, an observer might be able to observe the video image and to manually assign the annotations to the correct granularity level and regions on an unsophisticated, error-prone, time-consuming and labor intensive “trial and error” basis. However, until the present invention, no system or method had been devised to perform such an operation automatically.

An exemplary embodiment of the present invention receives a video image 300 along with annotations: “Indoors” 302, “Face” 304, “Phone” 306, and “Microphone” 308 which are only associated with the video image at the coarsest level as shown in FIG. 4.

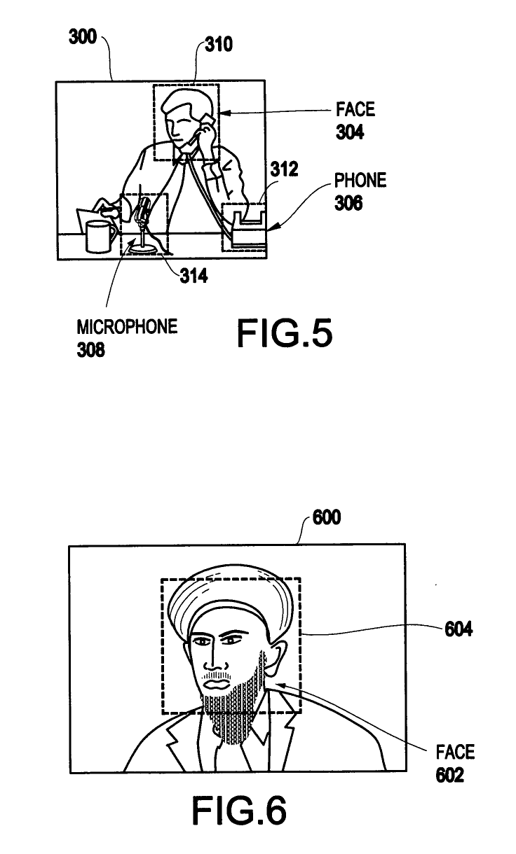

The exemplary embodiment of the invention may then process the video image 300 along with the annotations at the coarse level (e.g., at the entire image level, recognize the correspondence of regions of the images with the annotations, and assign (i.e. propagate) the annotations: “Indoors” 302, “Face” 304, “Phone” 306, and “Microphone” 308 to the finer granularity regions 310, 312 and 314 of the image 300 as shown in FIG. 5.

Yet another exemplary embodiment of the present invention may receive a video image 600 without any annotation at all. This exemplary embodiment of the invention is capable of mapping annotations to the appropriate level of granularity. As shown in FIG. 6, this exemplary embodiment of the present invention receives a video image 600 and, without further manual intervention, assigns the annotation “Face” 602 to the finer granularity level of the region 604.

Granularity of content generally refers to relative degrees of classification. For example, varying degrees of content may include images to regions; video to images to frames to regions; documents to chapters to words; portfolios to individual stocks; music albums to musical instruments, etc.

An exemplary embodiment of the present invention is capable of resolving an ambiguity of an annotation from a coarse level of granularity to a finer level of granularity using, for example, a discriminate learning algorithm.

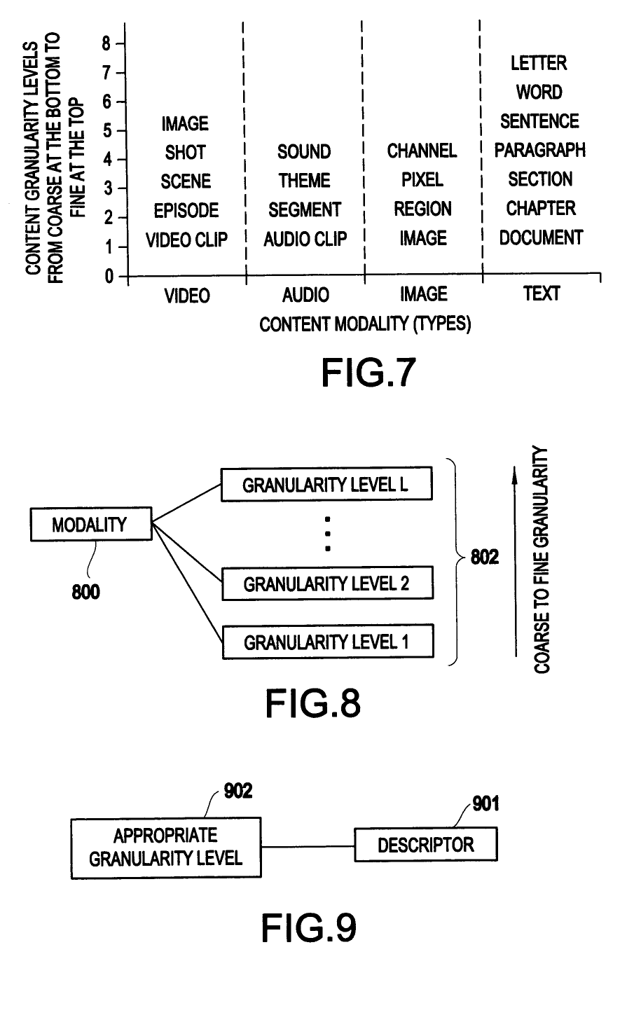

FIG. 7 illustrates various modalities and granularity levels of content. For example, FIG. 7 shows four modalities: video, audio, image, and text. FIG. 7 also shows varying levels of granularity for each of those modalities. For example, a coarse granularity level for the video modality may be a video clip, while a finer granularity level for the video modality may be an image within the video clip.

FIG. 8 shows a diagram that illustrates one modality 800 and corresponding granularity levels 802. The fineness of the granularity levels 802 increase from bottom to top in the diagram. Thus, granularity level 1 is the coarsest granularity level for this modality.

FIG. 9 shows a diagram that illustrates a descriptor 900 having an appropriate granularity level 902. While there may be many descriptors for each appropriate granularity level, an appropriate granularity level is a finest possible granularity level at which the descriptor may be completely or entirely observed.

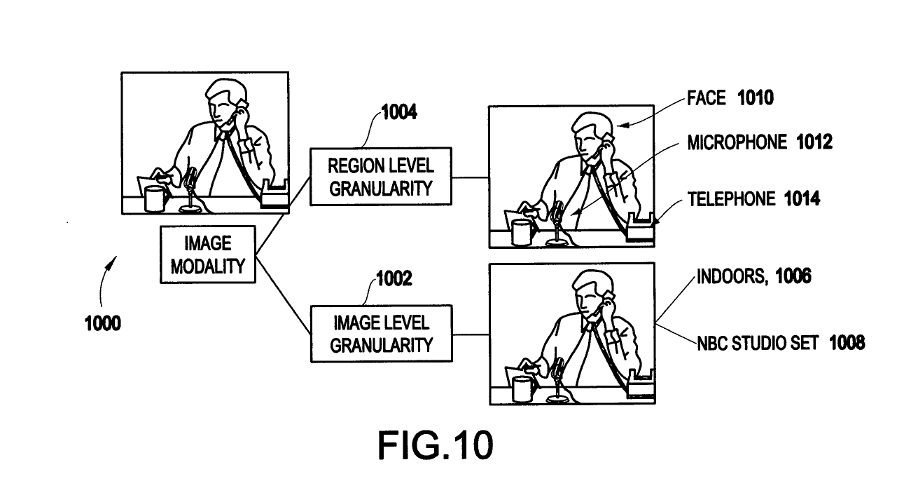

FIG. 10 shows an example of descriptors which are associated with multiple image granularities. In this example, the modality is an image modality 1000 and there are two levels of granularity: a coarse image level granularity 1002 and a finer region level granularity 1004. The coarse image level granularity 1002 includes annotations “Indoors” 1006 and “NBC Studio Set” 1008 while the finer region level granularity 1004 includes annotations “Face” 1010, “Microphone” 1012, and “Telephone” 1014.

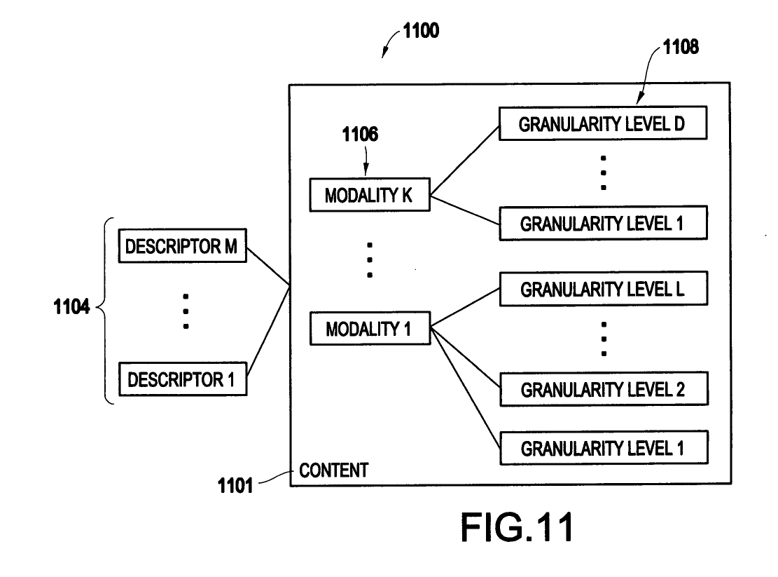

FIG. 11 illustrates an exemplar E^{L} 1100 that includes content 1102 and descriptors 1104. The content 1102 includes multiple modalities 1106 along with corresponding levels of granularity 1108.

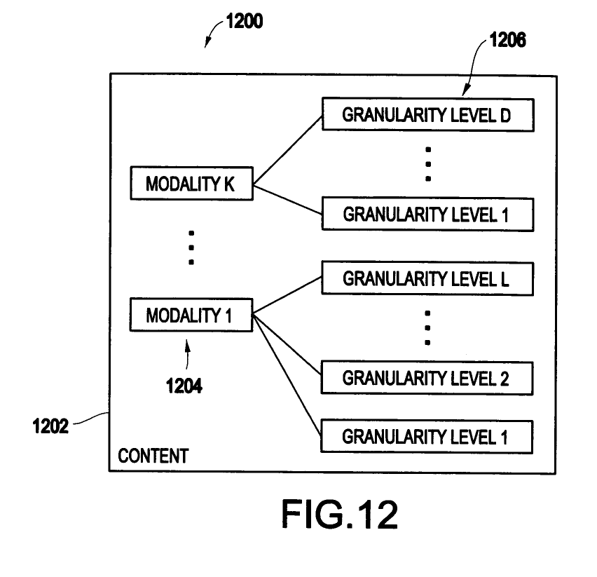

FIG. 12 illustrates an un-annotated exemplar E^{u} 1200 that includes content 1202 without any descriptors. The content 1202 includes multiple modalities 1204 along with corresponding levels of granularity 1206.

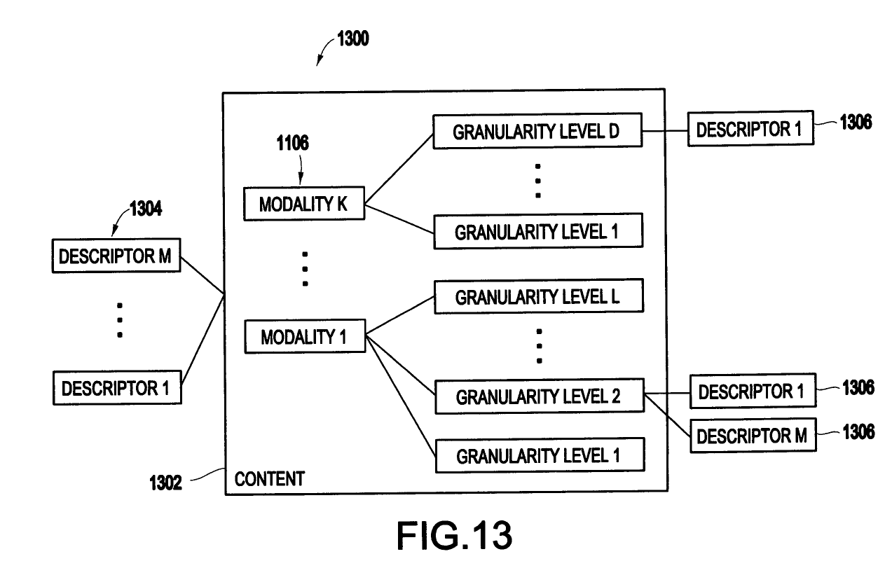

FIG. 13 illustrates an annotated exemplar E^{P} 1300 that includes content 1302, descriptors 1304 and propagated descriptors 1306. The propagated descriptors 1306 include the descriptors 1304 but have been propagated to the appropriate modality and granularity of the content 1302 with an exemplary embodiment of the present invention.

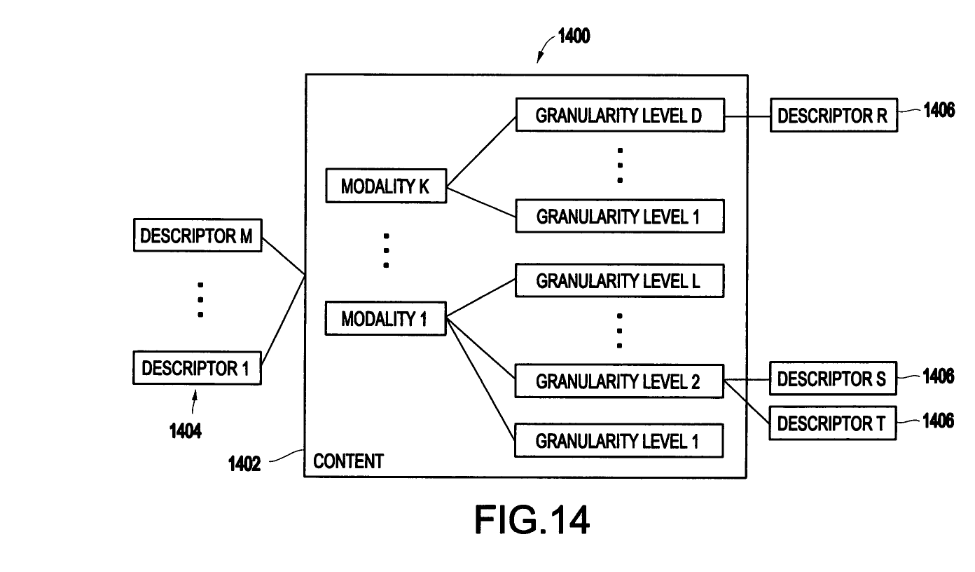

FIG. 14 illustrates an exemplar E^{M} 1400 that includes content 1402, descriptors 1404 and mapped descriptors 1406. Descriptors have been mapped by a descriptor mapping device in accordance with an exemplary embodiment of the invention (described in detail below) to provide the mapped descriptors 1406. One or more of the mapped descriptors 1406 may be distinct from the descriptors 1404.

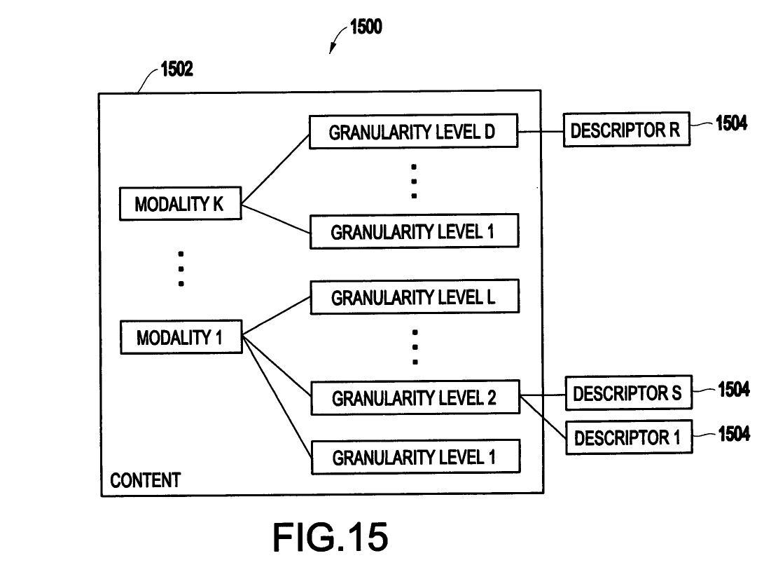

FIG. 15 illustrates an exemplar E^{C} 1500 that includes content 1502 and classified descriptors 1504. An exemplary embodiment of the present invention classifies descriptors to the appropriate content modality and granularity level using a descriptor classification device (described in detail below).

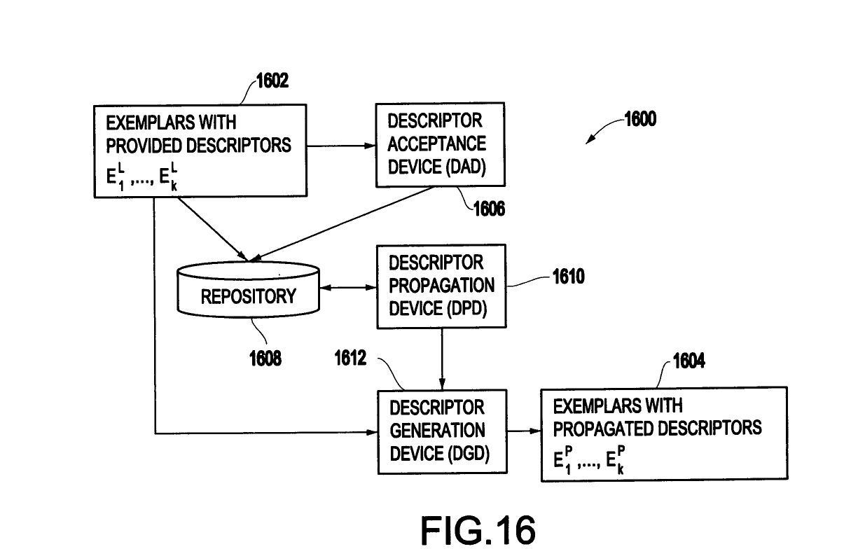

FIG. 16 shows an annotation propagation system 1600 in accordance with a first exemplary embodiment of the present invention. The annotation propagation system 1600 receives content exemplars along with descriptors E^{L}_{l,} . . . , E^{L}ₖ 1602, and outputs content exemplars with propagated descriptors E^{P}_{l,} . . . , E^{P}ₖ 1604. The annotation propagation system 1600 includes a descriptor acceptance device 1606 for receiving the exemplars with descriptors, a repository 1608 for storing the exemplars along with descriptors, a descriptor propagation device 1610 for analyzing the exemplars with descriptors to compute a propagation function, and a descriptor generation device 1612 for generating propagated descriptors based upon the computed propagation function and the exemplars with descriptors.

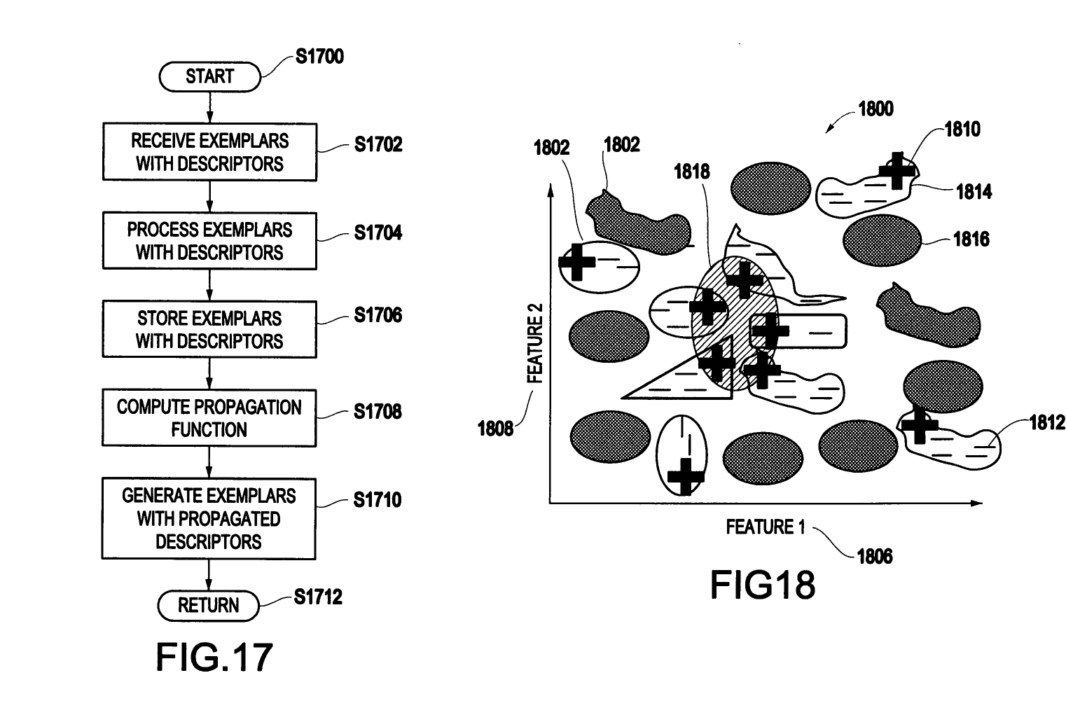

FIG. 17 shows a flow chart that illustrates an exemplary control routine for the annotation propagation system 1600 of FIG. 16.

The control routine starts at step S1700 and continues to step S1702, where the descriptor acceptance device 1606 receives the exemplars with descriptors E^{L}_{l,} . . . , E^{L}ₖ 1602. The control routine then continues to step S1704 where the descriptor acceptance device 1606 processes the exemplars with descriptors E^{L}_{l,} . . . , E^{L}ₖ 1602 and continues on to step S1706. In step S1706, the control routine stores the exemplars along with descriptors E^{L}_{l,} . . . , E^{L}ₖ 1602 in a repository 1608. Then in step S1708, the descriptor propagation device 1610 analyzes the exemplars with descriptors E^{L}_{l,} . . . , E^{L}ₖ 1602 to compute a propagation function. The control routine then continues to step 1710 where the descriptor generation device 1612 generates propagated descriptors E^{P}_{l,} . . . , E^{P}ₖ 1604 based upon the computed propagation function and the exemplars with descriptors E^{L}_{l,} . . . , E^{L}ₖ 1602.

In an exemplary embodiment of the invention, the descriptor propagation device 1610 may analyze the exemplars with descriptors E^{L}_{l,} . . . , E^{L}ₖ 1602 to compute a propagation function in accordance with the process illustrated by FIG. 18. FIG. 18 illustrates that video content may be described at an image level on a map 1800 of bags 1802 and each instance of a finer granularity is illustrated by dashes 1804 for each instance of a region within each image.

In accordance with this exemplary embodiment these images and regions are mapped in accordance with two features: feature 1 1806 and feature 2 1808. A feature may include any computational feature that may be derived from the content. As an example, feature 1 1806 may represent the number of red pixels in each image while feature 2 1808 may represent the number of red pixels in each image which are neighbors within the corresponding image. These features may, but are not required to be related to each other.

Based upon the mapping of the images (“bags”) and the instances (regions), these images may be further identified in accordance with whether each instance satisfies a criteria. If an instance satisfies a criteria, then that instance is positive as represented by the “+” sign 1810. Alternatively, those instances that do not satisfy the criteria are classified as a negative instance 1812. Then, each image may be classified as being a positive image 1814 if it includes a positive instance, and each image may be classified as being a negative image 1816 if it does not include a positive instance. The descriptor propagation device 1610 may then compute a propagation function by identifying a target space 1818 at an intersection of positive bags which is as far as possible from negative bags.

In this manner, an exemplary embodiment of the invention may process the exemplars with descriptors to generate a propagation function. This and other processes may be used to generate mapping functions and/or classification functions that are described below.

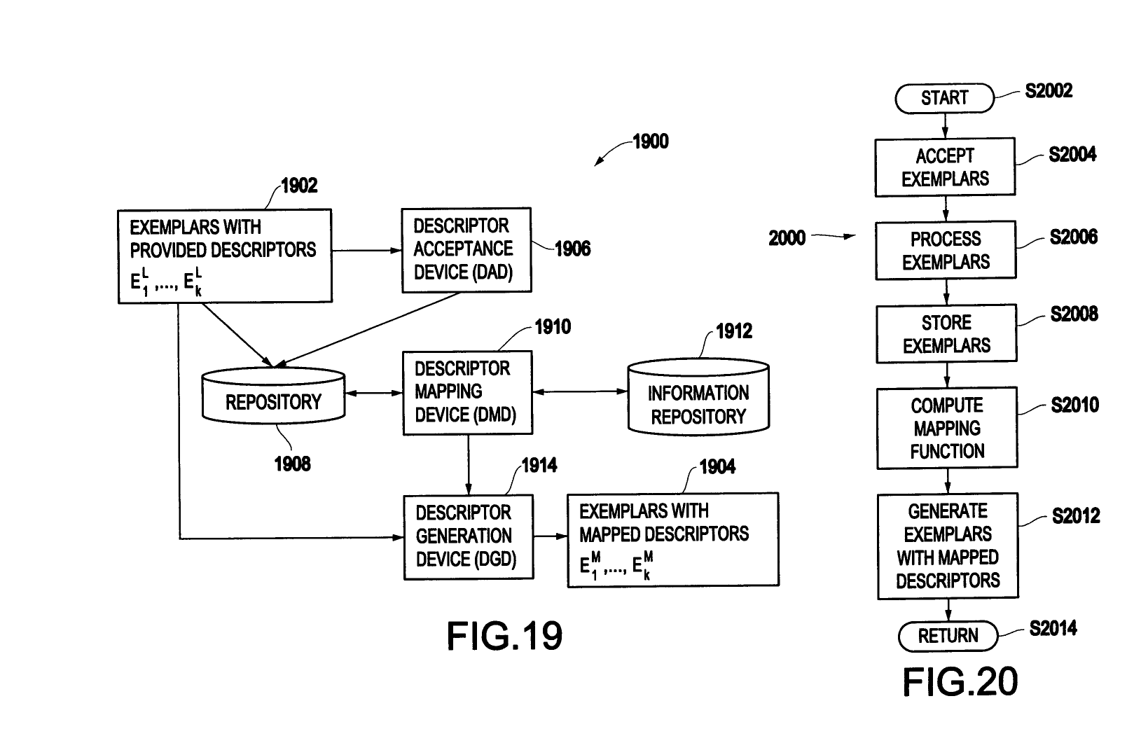

FIG. 19 illustrates an annotation mapping system 1900 in accordance with another exemplary embodiment of the present invention. The annotation mapping system 1900 differs from the annotation propagation system 1600 described above because the annotation mapping system 1900 is capable of mapping the descriptors based upon mapping functions which may have been based upon previous content exemplars with descriptors.

The annotation mapping system 1900 receives exemplars with descriptors E^{L}_{l,} . . . , E^{L}ₖ 1902 and outputs exemplars with mapped descriptors E^{M}_{l,} . . . , E^{M}ₖ 1904. The annotation mapping system 1900 includes a descriptor acceptance device 1906 for accepting exemplars with descriptors, a repository 1908 for storing the exemplars with descriptors, a descriptor mapping device 1910 for computing a mapping function based upon the exemplars with descriptors and the extracted features, an information repository 1912 for storing the mapping function and a descriptor generation device 1914 for generating exemplars with mapped descriptors based upon the exemplars with descriptors and the mapping function. The information repository 1912 may store rules for mapping descriptors while the repository 1908 may store the exemplars with descriptors E^{L}_{l,} . . . , E^{L}ₖ 1902 along with features that may have been extracted.

FIG. 20 illustrates an exemplary control routine 2000 for the annotation mapping system 1900 of FIG. 19.

The control routine 2000 starts at step S2002 and continues to step S2004. In step S2004, the descriptor acceptance device 1906 accepts the exemplars with descriptors E^{L}_{l,} . . . , E^{L}ₖ 1902 and the control routine continues to step S2006. In step S2006, the control routine processes the exemplars with descriptors E^{L}_{l,} . . . , E^{L}ₖ 1902 to extract features (as described above). Then in step S2008, the exemplars with descriptors E^{L}_{l,} . . . , E^{L}ₖ 1902 and the extracted features are stored in the repository 1908 by the control routine. The control routine then continues to step S2010 where the descriptor mapping device 1910 computes a mapping function based upon the exemplars with descriptors E^{L}_{l,} . . . , E^{L}ₖ 1902 and the extracted features. The control routine then continues to step S1914 where the descriptor generation device 1914 generates exemplars with mapped descriptors E^{M}_{l,} . . . , E^{M}ₖ 1904 based upon the exemplars with descriptors E^{L}_{l,} . . . , E^{L}ₖ 1902 and the mapping function. The control routine then continues to step S2014 where the control of the annotation mapping system is returned to the function that initiated the control routine 2000 of FIG. 20.

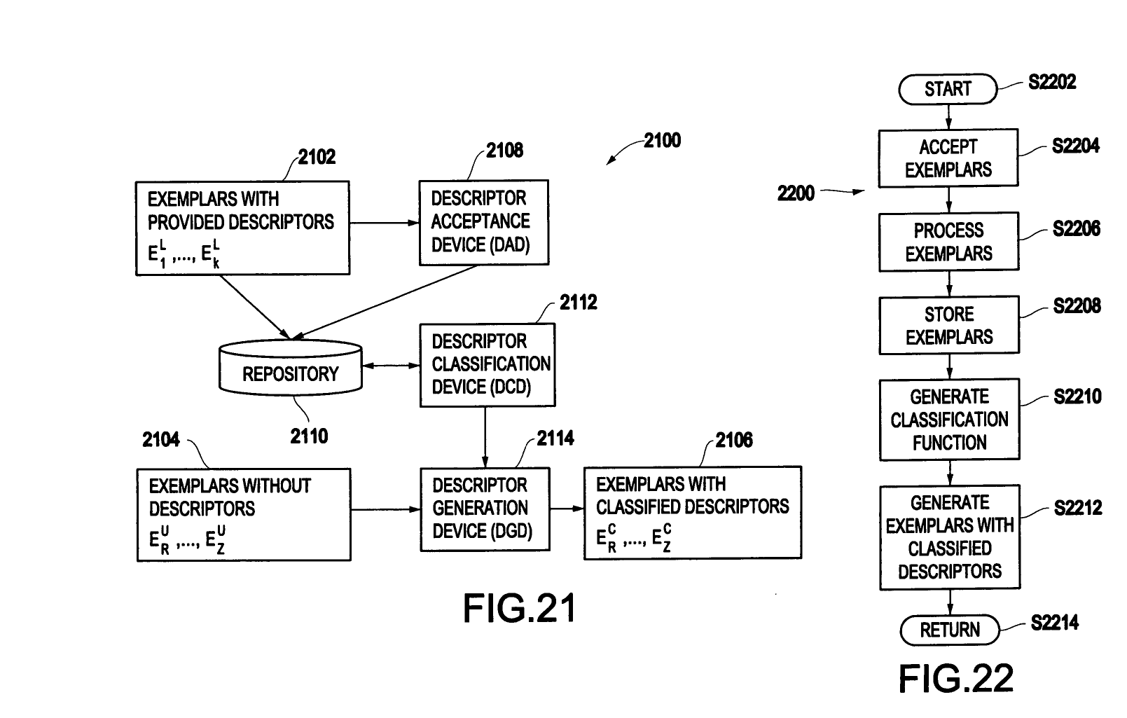

FIG. 21 illustrates an annotation classification system 2100 in accordance with yet another exemplary embodiment of the present invention. The annotation classification system 2100 differs from the above-described exemplary embodiments in that the annotation classification system 2100 is capable of providing descriptors to content exemplars which may not have previously included those descriptors.

The annotation classification system 2100 receives exemplars with descriptors E^{L}_{l,} . . . , E^{L}ₖ 2102 and exemplars without descriptors E_{R}^{u}_{l,} . . . , E_{R}^{u}ₖ 2104 outputs exemplars with classified descriptors E_{R}^{C}_{l,} . . . , E_{R}^{C}ₖ 2106. The annotation classification system 2100 includes a descriptor acceptance device 2108 for analyzing the exemplars with descriptors to extract features, a repository 2110 for storing the exemplars with descriptors and the extracted features, a descriptor classification device 2112 for generating a classification function based upon the exemplars with descriptors and the extracted features and a descriptor generation device 2114 for generating exemplars with classified descriptors which are based upon the exemplars without descriptors and the classification functions.

The annotation classification system 2100 is adapted to learn (e.g., is adaptive) based upon features extracted from the exemplars with descriptors E^{L}_{l,} . . . , E^{L}ₖ 2102 to generate classification functions that may be used to output exemplars with classified descriptors E_{R}^{C}_{l,} . . . , E_{R}^{C}ₖ 2106 which are based upon the exemplars without descriptors E_{R}^{u}_{l,} . . . , E_{R}^{u}ₖ 2104 and the classification functions.

FIG. 22 illustrates an exemplary control routine 2200 for the annotation classification system 2200. The control routine starts at step S2202 and continues to step S2204 where the descriptor acceptance device 2108 accepts the exemplars with descriptors E^{L}_{l,} . . . , E^{L}ₖ 2102 and continues to step S2206 where the descriptor acceptance device 2108 analyzes the exemplars with descriptors E^{L}_{l,} . . . , E^{L}ₖ 2102 to extract features and the control routine continues to step S2208 where the exemplars with descriptors E^{L}_{l,} . . . , E^{L}ₖ 2102 and the extracted features are store in the repository 2110. In step S2210, the descriptor classification device 2112 generates a classification function based upon the exemplars with descriptors E^{L}_{l,} . . . , E^{L}ₖ 2102 and the extracted features stored in the repository 2110 and the control routine continues to step S2212. In step S2212, the descriptor generation device 2114 generates exemplars with classified descriptors E_{R}^{C}_{l,} . . . , E_{R}^{C}ₖ 2106 which are based upon the exemplars without descriptors E_{R}^{u}_{l,} . . . , E_{R}^{u}ₖ 2104 and the classification functions. The control routine then continues to step S2214 where the control of the annotation classification system 2100 is returned to the function that initiated the control routine 2200 of FIG. 22.

While this detailed description generally describes exemplary embodiments of the invention which perform one of a propagation, mapping and classification function for the descriptors, the present invention is not limited to these embodiments and may also be used to combine and/or mix together any of these propagation, mapping and classification functions.

While this detailed description exemplarily describes annotating video and/or image content, the present invention is not limited to any type of content. For example, the present invention may also be used to annotate documents, music or any other data stream which may be represented at varying degrees of granularity.

While the invention has been described in terms of several exemplary embodiments, those skilled in the art will recognize that the invention can be practiced with modification.

Further, it is noted that Applicants' intent is to encompass equivalents of all claim elements, even if amended later during prosecution.

1. A descriptor propagation system comprising:
a descriptor acceptance device that accepts a first descriptor associated with a first content granularity; and
a descriptor generator device that generates a second descriptor associated with a second content granularity based on the first descriptor, wherein the second content granularity is finer than the first content granularity.

2. The system of claim 1, further comprising:
a descriptor propagation device that generates a propagation function based upon the first descriptor and the first content granularity,
wherein the descriptor generator device generates the second descriptor based upon the propagation function and the first descriptor.

3. The system of claim 1, further comprising:
a repository that stores the first descriptor associated with the first content granularity.

4. A descriptor mapping system, comprising:
a descriptor acceptance device that accepts a first descriptor at a first content granularity;
an information repository that stores a mapping function; and
a descriptor generator device that generates a second descriptor at a second content granularity which is finer than the first content granularity based upon the first descriptor and the mapping function.

5. The system of claim 4, wherein the second descriptor is different than the first descriptor and is stored in the information repository.

6. The system of claim 4, further comprising:
a descriptor mapping device that generates another mapping function based upon the first descriptor and the first content granularity, and that stores the second mapping function in the information repository.

7. The system of claim 4, further comprising:
a repository that stores the first descriptor associated with a first content granularity.

8. A descriptor classification system, comprising:
a descriptor acceptance device that accepts a first content that includes a first descriptor at a first content granularity; and
a descriptor generator device that generates an output content that includes the first descriptor at a second content granularity based upon a second content at the first content granularity,
wherein the second content granularity is finer than the first content granularity.

9. The system of claim 8, further comprising:
a descriptor classification device that generates a classification function based upon the first content, and
wherein the descriptor generator device generates the output content based upon the classification function and the second content at the first content granularity.

10. A method for propagating descriptors, comprising:
analyzing a first content at a first content granularity to determine a propagation function that correlates a first descriptor provided for the first content to a second content granularity that is finer than the first content granularity; and
outputting the first descriptor at the second content granularity.

11. The method of claim 10, wherein analyzing the first content to determine the propagation function comprises extracting features from the first content.

12. A method for mapping descriptors, comprising:
mapping a first descriptor at a first content granularity to a second content granularity that is finer than the first content granularity based upon a mapping function; and
outputting the first descriptor at the second content granularity.

13. The method of claim 12, wherein the mapping function is stored in an information repository.

14. The method of claim 12, wherein the second descriptor is different than the first descriptor and is stored in an information repository.

15. The method of claim 12, further comprising analyzing the first descriptor to generate another mapping function.

16. A method for classifying descriptors comprising:
generating a classification function based upon a first descriptor for a first content at a first content granularity;
accepting a second content that does not include a descriptor; and
providing the first descriptor to the second content at a second content granularity that is finer than the first content granularity based upon the classification function.

17. A signal-bearing medium tangibly embodying a program of machine-readable instructions executable by a digital processing apparatus to perform a method of propagating descriptors, comprising:
instructions for generating a classification function based upon a first descriptor for a first content at a first content granularity;
instructions for accepting a second content that does not include a descriptor; and
instructions for providing the first descriptor to the second content at a second content granularity that is finer than the first content granularity based upon the classification function.

18. A signal-bearing medium tangibly embodying a program of machine-readable instructions executable by a digital processing apparatus to perform a method of mapping descriptors, comprising:
instructions for mapping a first descriptor at a first content granularity to a second content granularity that is finer than the first content granularity based upon a mapping function; and
instructions for outputting the first descriptor at the second content granularity.

19. The medium of claim 18, wherein the second descriptor is different than the first descriptor and is stored in an information repository.

20. A signal-bearing medium tangibly embodying a program of machine-readable instructions executable by a digital processing apparatus to perform a method of classifying descriptors, comprising:
instructions for generating a classification function based upon a first descriptor for a first content at a first content granularity;
instructions for accepting a second content that does not include a descriptor; and
instructions for providing the first descriptor to the second content at a second content granularity that is finer than the first content granularity based upon the classification function.

21. A method of deploying computing infrastructure in which computer-readable code is integrated into a computing system, such that said code and said computing system combine to perform a method for propagating descriptors, said method comprising:
analyzing a first content at a first content granularity to determine a propagation function that correlates a first descriptor provided for the first content to a second content granularity that is finer than the first content granularity; and
outputting the first descriptor at the second content granularity.

22. A method of deploying computing infrastructure in which computer-readable code is integrated into a computing system, such that said code and said computing system combine to perform a method for mapping descriptors, said method comprising:
mapping a first descriptor at a first content granularity to a second content granularity that is finer than the first content granularity based upon a mapping function; and
outputting the first descriptor at the second content granularity.

23. A method of deploying computing infrastructure in which computer-readable code is integrated into a computing system, such that said code and said computing system combine to perform a method for classifying descriptors, said method comprising:
generating a classification function based upon a first descriptor for a first content at a first content granularity;
accepting a second content that does not include a descriptor; and providing the first descriptor to the second content at a second content granularity that is finer than the first content granularity based upon the classification function.
